(19) United States
(12) Patent Application Publication
(10) Pub. No.: US 2013/0269632 A1
(43) Pub. Date: Oct. 17, 2013

(54) COMPRESSED AIR ENERGY STORAGE SYSTEMS WITH SPLIT-CYCLE ENGINES

(71) Applicant: SCUDERI GROUP, INC., West Springfield, MA (US)

(72) Inventors: Riccardo Meldolesi, East Sussex (GB); Stephen P. Scuderi, Westfield, MA (US); Salvatore C. Scuderi, Westfield, MA (US)

(21) Appl. No.: 13/859,354

(22) Filed: Apr. 9, 2013

Related U.S. Application Data
(60) Provisional application No. 61/623,850, filed on Apr. 13, 2012.

(51) Int. Cl. F02B 63/04

(52) U.S. Cl. CPC F02B 63/04
USPC 123/2

(57) ABSTRACT

In some embodiments, systems are provided in which electric power generated from a renewable energy source such as a solar or wind power system during low demand periods is used to drive an electric motor which turns an air hybrid split-cycle engine. The split-cycle engine operates in AC mode during this time to compress air into a storage tank. Later, during high demand periods, compressed air stored in the tank and added fuel are fed to the split-cycle engine, which operates in AEF mode. The work generated by the split-cycle engine turns a generator to produce electric power. When the supply of compressed air stored in the storage tank is depleted, the split-cycle engine can operate in an NF mode to serve as a backup generator, or in an FC mode to serve as a backup generator while simultaneously recharging the air storage tank.

### CROSS-REFERENCE TO RELATED APPLICATIONS

This application claims the benefit of priority of U.S. Provisional Patent Application No. 61/623,850, filed on Apr. 13, 2012, the entire contents of which are hereby incorporated by reference.

### FIELD

The present invention relates to compressed air energy storage systems and related methods. In some embodiments, the invention relates to compressed air energy storage systems and related methods that involve split-cycle internal combustion engines.

### BACKGROUND

Engine Technology

For purposes of clarity, the term “conventional engine” as used in the present application refers to an internal combustion engine wherein all four strokes of the well-known Otto cycle (the intake, compression, expansion and exhaust strokes) are contained in each piston/cylinder combination of the engine. Each stroke requires one half revolution of the crankshaft (180 degrees crank angle (“CA”)), and two full revolutions of the crankshaft (720 degrees CA) are required to complete the entire Otto cycle in each cylinder of a conventional engine.

Also, for purposes of clarity, the following definition is offered for the term “split-cycle engine” as may be applied to engines disclosed in the prior art and as referred to in the present application.

A split-cycle engine generally comprises:

a crankshaft rotatable about a crankshaft axis;

a compression piston slidably received within a compression cylinder and operatively connected to the crankshaft such that the compression piston reciprocates through an intake stroke and a compression stroke during a single rotation of the crankshaft;

an expansion (power) piston slidably received within an expansion cylinder and operatively connected to the crankshaft such that the expansion piston reciprocates through an expansion stroke and an exhaust stroke during a single rotation of the crankshaft; and

a crossover passage interconnecting the compression and expansion cylinders, the crossover passage including at least a crossover expansion (XovrE) valve disposed therein, but more preferably including a crossover compression (XovrC) valve and a crossover expansion (XovrE) valve defining a pressure chamber therebetween.

A split-cycle air hybrid engine combines a split-cycle engine with an air reservoir (also commonly referred to as an air tank) and various controls. This combination enables the engine to store energy in the form of compressed air in the air reservoir. The compressed air in the air reservoir is later used in the expansion cylinder to power the crankshaft. In general, a split-cycle air hybrid engine as referred to herein comprises:

a crankshaft rotatable about a crankshaft axis;

a compression piston slidably received within a compression cylinder and operatively connected to the crankshaft such that the compression piston reciprocates through an intake stroke and a compression stroke during a single rotation of the crankshaft;

an expansion (power) piston slidably received within an expansion cylinder and operatively connected to the crankshaft such that the expansion piston reciprocates through an expansion stroke and an exhaust stroke during a single rotation of the crankshaft;

a crossover passage (port) interconnecting the compression and expansion cylinders, the crossover passage including at least a crossover expansion (XovrE) valve disposed therein, but more preferably including a crossover compression (XovrC) valve and a crossover expansion (XovrE) valve defining a pressure chamber therebetween; and

an air reservoir operatively connected to the crossover passage and selectively operable to store compressed air from the compression cylinder and to deliver compressed air to the expansion cylinder.

FIG. 1 illustrates one exemplary embodiment of a prior art split-cycle air hybrid engine. The split-cycle engine 100 replaces two adjacent cylinders of a conventional engine with a combination of one compression cylinder 102 and one expansion cylinder 104. The compression cylinder 102 and the expansion cylinder 104 are formed in an engine block in which a crankshaft 106 is rotatably mounted. Upper ends of the cylinders 102, 104 are closed by a cylinder head 130. The crankshaft 106 includes axially displaced and angularly offset first and second crank throws 126, 128, having a phase angle therebetween. The first crank throw 126 is pivotally joined by a first connecting rod 138 to a compression piston 110, and the second crank throw 128 is pivotally joined by a second connecting rod 140 to an expansion piston 120 to reciprocate the pistons 110, 120 in their respective cylinders 102, 104 in a timed relation determined by the angular offset of the crank throws and the geometric relationships of the cylinders, crank, and pistons. Alternative mechanisms for relating the motion and timing of the pistons can be utilized if desired. The rotational direction of the crankshaft and the relative motions of the pistons near their bottom dead center (BDC) positions are indicated by the arrows associated in the drawings with their corresponding components.

The four strokes of the Otto cycle are thus “split” over the two cylinders 102 and 104 such that the compression cylinder 102 contains the intake and compression strokes and the expansion cylinder 104 contains the expansion and exhaust strokes. The Otto cycle is therefore completed in these two cylinders 102, 104 once per crankshaft 106 revolution (360 degrees CA).

During the intake stroke, intake air is drawn into the compression cylinder 102 through an inwardly-opening (opening inward into the cylinder and toward the piston) poppet intake valve 108. During the compression stroke, the compression piston 110 pressurizes the air charge and drives the air charge through a crossover passage 112, which acts as the intake passage for the expansion cylinder 104. The engine 100 can have one or more crossover passages 112.

The volumetric (or geometric) compression ratio of the compression cylinder 102 of the split-cycle engine 100 (and for split-cycle engines in general) is herein referred to as the “compression ratio” of the split-cycle engine. The volumetric (or geometric) compression ratio of the expansion cylinder 104 of the engine 100 (and for split-cycle engines in general) is herein referred to as the “expansion ratio” of the split-cycle engine. The volumetric compression ratio of a cylinder is well known in the art as the ratio of the enclosed (or trapped) volume in the cylinder (including all recesses) when a piston reciprocating therein is at its BDC position to the enclosed volume (i.e., clearance volume) in the cylinder when said piston is at its top dead center (TDC) position. Specifically for split-cycle engines as defined herein, the compression ratio of a compression cylinder is determined when the XovrC valve is closed. Also specifically for split-cycle engines as defined herein, the expansion ratio of an expansion cylinder is determined when the XovrE valve is closed.

Due to very high volumetric compression ratios (e.g., 20 to 1, 30 to 1, 40 to 1, or greater) within the compression cylinder 102, an outwardly-opening (opening outwardly away from the cylinder and piston) poppet crossover compression (XovrC) valve 114 at the inlet of the crossover passage 112 is used to control flow from the compression cylinder 102 into the crossover passage 112. Due to very high volumetric compression ratios (e.g., 20 to 1, 30 to 1, 40 to 1, or greater) within the expansion cylinder 104, an outwardly-opening poppet crossover expansion (XovrE) valve 116 at the outlet of the crossover passage 112 controls flow from the crossover passage 112 into the expansion cylinder 104. The actuation rates and phasing of the XovrC and XovrE valves 114, 116 are timed to maintain pressure in the crossover passage 112 at a high minimum pressure (typically 20 bar or higher at full load) during all four strokes of the Otto cycle.

At least one fuel injector 118 injects fuel into the pressurized air at the exit end of the crossover passage 112 in coordination with the XovrE valve 116 opening. Alternatively, or in addition, fuel can be injected directly into the expansion cylinder 104. The fuel-air charge fully enters the expansion cylinder 104 shortly after the expansion piston 120 reaches its TDC position. As the piston 120 begins its descent from its TDC position, and while the XovrE valve 116 is still open, one or more spark plugs 122 are fired to initiate combustion (typically between 10 to 20 degrees CA after TDC of the expansion piston 120). Combustion can be initiated while the expansion piston is between 1 and 30 degrees CA past its TDC position. More preferably, combustion can be initiated while the expansion piston is between 5 and 25 degrees CA past its TDC position. Most preferably, combustion can be initiated while the expansion piston is between 10 and 20 degrees CA past its TDC position. Additionally, combustion can be initiated through other ignition devices and/or methods, such as with glow plugs, microwave ignition devices, or through compression ignition methods.

The XovrE valve 116 is then closed before the resulting combustion event enters the crossover passage 112. The combustion event drives the expansion piston 120 downward in a power stroke. Exhaust gases are pumped out of the expansion cylinder 104 through an inwardly-opening poppet exhaust valve 124 during the exhaust stroke.

With the split-cycle engine concept, the geometric engine parameters (i.e., bore, stroke, connecting rod length, compression ratio, etc.) of the compression and expansion cylinders are generally independent from one another. For example, the crank throws 126, 128 for the compression cylinder 102 and expansion cylinder 104, respectively, have different radii and are phased apart from one another with TDC of the expansion piston 120 occurring prior to TDC of the compression piston 110. This independence enables the split-cycle engine to potentially achieve higher efficiency levels and greater torques than typical four-stroke engines.

The geometric independence of engine parameters in the split-cycle engine 100 is also one of the main reasons why pressure can be maintained in the crossover passage 112 as discussed earlier. Specifically, the expansion piston 120 reaches its TDC position prior to the compression piston 110 reaching its TDC position by a discrete phase angle (typically between 10 and 30 crank angle degrees). This phase angle, together with proper timing of the XovrC valve 114 and the XovrE valve 116, enables the split-cycle engine 100 to maintain pressure in the crossover passage 112 at a high minimum pressure (typically 20 bar absolute or higher during full load operation) during all four strokes of its pressure/volume cycle. That is, the split-cycle engine 100 is operable to time the XovrC valve 114 and the XovrE valve 116 such that the XovrC and XovrE valves 114, 116 are both open for a substantial period of time (or period of crankshaft rotation) during which the expansion piston 120 descends from its TDC position towards its BDC position and the compression piston 110 simultaneously ascends from its BDC position towards its TDC position. During the period of time (or crankshaft rotation) that the crossover valves 114, 116 are both open, a substantially equal mass of gas is transferred (1) from the compression cylinder 102 into the crossover passage 112 and (2) from the crossover passage 112 to the expansion cylinder 104. Accordingly, during this period, the pressure in the crossover passage is prevented from dropping below a predetermined minimum pressure (typically 20, 30, or 40 bar absolute during full load operation). Moreover, during a substantial portion of the intake and exhaust strokes (typically 90% of the entire intake and exhaust strokes or greater), the XovrC valve 114 and XovrE valve 116 are both closed to maintain the mass of trapped gas in the crossover passage 112 at a substantially constant level. As a result, the pressure in the crossover passage 112 is maintained at a predetermined minimum pressure during all four strokes of the engine's pressure/volume cycle.

For purposes herein, the method of opening the XovrC 114 and XovrE 116 valves while the expansion piston 120 is descending from TDC and the compression piston 110 is ascending toward TDC in order to simultaneously transfer a substantially equal mass of gas into and out of the crossover passage 112 is referred to as the “push-pull” method of gas transfer. It is the push-pull method that enables the pressure in the crossover passage 112 of the engine 100 to be maintained at typically 20 bar or higher during all four strokes of the engine's cycle when the engine is operating at full load.

The crossover valves 114, 116 are actuated by a valve train that includes one or more cams (not shown). In general, a cam-driven mechanism includes a camshaft mechanically linked to the crankshaft. One or more cams are mounted to the camshaft, each having a contoured surface that controls the valve lift profile of the valve event (i.e., the event that occurs during a valve actuation). The XovrC valve 114 and the XovrE valve 116 each can have its own respective cam and/or its own respective camshaft. As the XovrC and XovrE cams rotate, eccentric portions thereof impart motion to a rocker arm, which in turn imparts motion to the valve, thereby lifting (opening) the valve off of its valve seat. As the cam continues to rotate, the eccentric portion passes the rocker arm and the valve is allowed to close.

The split-cycle air hybrid engine 100 also includes an air reservoir (tank) 142, which is operatively connected to the crossover passage 112 by an air reservoir tank valve 152. Embodiments with two or more crossover passages 112 may include a tank valve 152 for each crossover passage 112 which connect to a common air reservoir 142, may include a single valve which connects all crossover passages 112 to a common air reservoir 142, or each crossover passage 112 may operatively connect to separate air reservoirs 142.

The tank valve 152 is typically disposed in an air tank port 154, which extends from the crossover passage 112 to the air tank 142. The air tank port 154 is divided into a first air tank port section 156 and a second air tank port section 158. The first air tank port section 156 connects the air tank valve 152 to the crossover passage 112, and the second air tank port section 158 connects the air tank valve 152 to the air tank 142. The volume of the first air tank port section 156 includes the volume of all additional recesses which connect the tank valve 152 to the crossover passage 112 when the tank valve 152 is closed. Preferably, the volume of the first air tank port section 156 is small relative to the second air tank port section 158. More preferably, the first air tank port section 156 is substantially non-existent, that is, the tank valve 152 is most preferably disposed such that it is flush against the outer wall of the crossover passage 112.

The tank valve 152 may be any suitable valve device or system. For example, the tank valve 152 may be an active valve which is activated by various valve actuation devices (e.g., pneumatic, hydraulic, cam, electric, or the like). Additionally, the tank valve 152 may comprise a tank valve system with two or more valves actuated with two or more actuation devices.

The air tank 142 is utilized to store energy in the form of compressed air and to later use that compressed air to power the crankshaft 106. This mechanical means for storing potential energy provides numerous potential advantages over the current state of the art. For instance, the split-cycle air hybrid engine 100 can potentially provide many advantages in fuel efficiency gains and NOx emissions reduction at relatively low manufacturing and waste disposal costs in relation to other technologies on the market, such as diesel engines and electric-hybrid systems.

The engine 100 typically runs in a normal operating or firing (NF) mode (also commonly called the engine firing (EF) mode) and one or more of four basic air hybrid modes. In the EF mode, the engine 100 functions normally as previously described in detail herein, operating without the use of the air tank 142. In the EF mode, the air tank valve 152 remains closed to isolate the air tank 142 from the basic split-cycle engine. In the four air hybrid modes, the engine 100 operates with the use of the air tank 142.

The four basic air hybrid modes include:

1) Air Expander (AE) mode, which includes using compressed air energy from the air tank 142 without combustion;

2) Air Compressor (AC) mode, which includes storing compressed air energy into the air tank 142 without combustion;

3) Air Expander and Firing (AEF) mode, which includes using compressed air energy from the air tank 142 with combustion; and

4) Firing and Charging (FC) mode, which includes storing compressed air energy into the air tank 142 with combustion.

Further details on split-cycle engines can be found in U.S. Pat. No. 6,543,225 entitled Split Four Stroke Cycle Internal Combustion Engine and issued on Apr. 8, 2003; and U.S. Pat. No. 6,952,923 entitled Split-Cycle Four-Stroke Engine and issued on Oct. 11, 2005, each of which is incorporated by reference herein in its entirety.

Further details on air hybrid engines are disclosed in U.S. Pat. No. 7,353,786 entitled Split-Cycle Air Hybrid Engine and issued on Apr. 8, 2008; U.S. Patent Application No. 61/365,343 entitled Split-Cycle Air Hybrid Engine and filed on Jul. 18, 2010; and U.S. Patent Application No. 61/313,831 entitled Split-Cycle Air Hybrid Engine and filed on Mar. 15, 2010, each of which is incorporated by reference herein in its entirety.

Power Systems

A number of systems have been proposed or developed to generate power from renewable sources such as solar and wind energy. In general, the demand for output power from such systems almost never matches the supply of input energy. Invariably, there will be periods of low sunlight, low wind, or high demand during which the output power is insufficient to supply the attached load, or periods of high sunlight, high wind, or low demand during which the system generates more output power than required by the attached load.

Compressed air energy storage (CAES) systems have been proposed in an attempt to address this issue by storing excess energy as compressed air during periods of low demand/high supply and then supplying the stored energy during periods of high demand/low supply.

In an exemplary CAES system, electric power generated during low demand periods is used to turn an electric motor coupled to a compressor turbine. Air that is compressed by the compressor turbine is stored in large underground caves which are sealed to facilitate storage of the compressed air. Later, during high demand periods, compressed air stored in the caves is fed into gas-fired turbines which are coupled to generators for producing electric power.

While these systems show some promise, they suffer from certain disadvantages. For example, these systems require a very specific geology (i.e., a sealable cave with a very large volume capable of holding air stored at very high pressures—more than 70 bar in some instances). As a result, these systems are typically built in remote mountainous regions, and require significant infrastructure to transport generated energy to the ultimate load. This introduces a number of transmission losses that reduce the overall efficiency of the system.

In addition, these systems must generally be massive in scale. This is in part because the enormous cost of building such systems makes them economically impractical for small scale applications. Also, as the size of the turbines becomes smaller, the gap between the fan blades and the shroud where the majority of turbine efficiency losses are introduced becomes proportionally larger. Thus, very large turbines are required to maintain the requisite efficiency. In view of the foregoing, there is a need for CAES systems having improved efficiency and that are scalable to smaller applications.

### SUMMARY

Compressed air energy storage (CAES) systems are disclosed herein which are more conducive to small scale application and which can operate with greater efficiency than existing systems.

In some embodiments, systems are provided in which electric power generated from a renewable energy source such as a solar or wind power system during low demand periods is used to drive an electric motor which turns an air hybrid split-cycle engine. The split-cycle engine operates in AC mode during this time to compress air into a storage tank. Later, during high demand periods, compressed air stored in the tank and added fuel are fed to the split-cycle engine, which operates in AEF mode. The work generated by the split-cycle engine turns a generator to produce electric power. When the supply of compressed air stored in the storage tank is depleted, the split-cycle engine can operate in an NF mode to serve as a backup generator, or in an FC mode to serve as a backup generator while simultaneously recharging the air storage tank.

For a given output power, these systems can require less than half the space of existing CAES systems and can operate with greater efficiency and at lower pressures (e.g., about 30 bar storage pressure as opposed to more than 70 bar storage pressure). This allows for small footprint designs that can be placed proximate to the ultimate load and that can be economically built on a small scale.

In one aspect of at least one embodiment of the invention, a compressed air energy storage system is provided that includes a split-cycle engine, an electric motor/generator operatively coupled to a crankshaft of the split-cycle engine, and an air storage tank in fluid communication with a crossover passage of the split-cycle engine. The system is operable in at least an energy storage mode in which energy supplied from a power grid drives the electric motor/generator to turn the split-cycle engine to store compressed air in the air storage tank. The system is also operable in at least an energy conversion mode in which compressed air stored in the air storage tank is supplied with fuel to the split-cycle engine and combusted to drive the electric motor/generator and supply electric power to the power grid.

Related aspects of at least one embodiment of the invention provide a system, e.g., as described above, in which the split-cycle engine operates in AC mode during the energy storage mode of system operation.

Related aspects of at least one embodiment of the invention provide a system, e.g., as described above, in which the split-cycle engine operates in AEF mode during the energy conversion mode of system operation.

Related aspects of at least one embodiment of the invention provide a system, e.g., as described above, in which the fuel comprises at least one of natural gas and bio-gas.

Related aspects of at least one embodiment of the invention provide a system, e.g., as described above, in which the system is also operable in a backup energy generation mode in which the split-cycle engine operates in an NF mode to drive the electric motor/generator to supply electric power to the power grid.

Related aspects of at least one embodiment of the invention provide a system, e.g., as described above, in which the system is also operable in a backup energy generation and recharge mode in which the split-cycle engine operates in an FC mode to drive the electric motor/generator to supply electric power to the power grid and to simultaneously store compressed air in the air storage tank.

Related aspects of at least one embodiment of the invention provide a system, e.g., as described above, in which the system operates in the energy storage mode when energy supplied from the power grid exceeds energy demand.

Related aspects of at least one embodiment of the invention provide a system, e.g., as described above, in which the system operates in the energy conversion mode when energy supplied from the power grid does not exceed energy demand and there is compressed air stored in the air storage tank.

Related aspects of at least one embodiment of the invention provide a system, e.g., as described above, in which the system operates in the backup energy generation mode when energy supplied from the power grid does not exceed energy demand and there is no compressed air stored in the air storage tank.

Related aspects of at least one embodiment of the invention provide a system, e.g., as described above, in which the power grid includes a renewable energy source, such as at least one of a wind power system, a solar power system, a hydroelectric power system, and a geothermal power system.

In another aspect of at least one embodiment of the invention, a method of operating a compressed air energy storage system is provided. The method includes, in an energy storage mode, driving an electric motor/generator with energy from a power grid to turn a split-cycle engine to store compressed air in an air storage tank. The method also includes, in an energy conversion mode, combusting a mixture of fuel and compressed air supplied from the air storage tank in the split-cycle engine to drive the electric motor/generator and supply electric power to the power grid.

Related aspects of at least one embodiment of the invention provide a method, e.g., as described above, that includes operating the split-cycle engine in AC mode during the energy storage mode of system operation.

Related aspects of at least one embodiment of the invention provide a method, e.g., as described above, that includes operating the split-cycle engine in AEF mode during the energy conversion mode of system operation.

Related aspects of at least one embodiment of the invention provide a method, e.g., as described above, in which the fuel comprises at least one of natural gas and bio-gas.

Related aspects of at least one embodiment of the invention provide a method, e.g., as described above, that includes, in a backup energy generation mode, operating the split-cycle engine in an NF mode to drive the electric motor/generator to supply electric power to the power grid.

Related aspects of at least one embodiment of the invention provide a method, e.g., as described above, that includes, in a backup energy generation and recharge mode, operating the split-cycle engine in an FC mode to drive the electric motor/generator to supply electric power to the power grid and to simultaneously store compressed air in the air storage tank.

Related aspects of at least one embodiment of the invention provide a method, e.g., as described above, in which the energy storage mode is used when energy supplied from the power grid exceeds energy demand.

Related aspects of at least one embodiment of the invention provide a method, e.g., as described above, in which the energy conversion mode is used when energy supplied from the power grid does not exceed energy demand and there is compressed air stored in the air storage tank.

Related aspects of at least one embodiment of the invention provide a method, e.g., as described above, in which the backup energy generation mode is used when energy supplied from the power grid does not exceed energy demand and there is no compressed air stored in the air storage tank.

Related aspects of at least one embodiment of the invention provide a method, e.g., as described above, in which the power grid includes a renewable energy source, such as at least one of a wind power system, a solar power system, a hydroelectric power system, and a geothermal power system.

In another aspect of at least one embodiment of the invention, a cylinder deactivation system is provided that includes a first crankshaft having a first crank throw coupled to a compression piston of a split-cycle engine, and a second crankshaft having a second crank throw coupled to an expansion piston of the split-cycle engine. The system also includes a first clutch configured to selectively couple the first crankshaft to a first pulley shaft having a first pulley mounted thereon, and a second clutch configured to selectively couple the second crankshaft to a second pulley shaft having a second pulley mounted thereon. The system also includes an output shaft having an output pulley mounted thereon, and a linkage configured to transmit rotation between each of the first pulley, the second pulley, and the output pulley.

Related aspects of at least one embodiment of the invention provide a system, e.g., as described above, in which actuating the first clutch decouples the first crankshaft from the first pulley shaft such that the compression piston remains stationary while the expansion piston reciprocates to drive the output shaft.

Related aspects of at least one embodiment of the invention provide a system, e.g., as described above, in which actuating the second clutch decouples the second crankshaft from the second pulley shaft such that the expansion piston remains stationary while the compression piston reciprocates as the output shaft is externally driven.

Related aspects of at least one embodiment of the invention provide a system, e.g., as described above, in which the linkage comprises at least one of a belt and a chain.

In another aspect of at least one embodiment of the invention, an air expander is provided that includes a cylinder, a piston reciprocally disposed in the cylinder and coupled to a crankshaft, an intake valve configured to control fluid communication between the cylinder and an air storage tank, and an exhaust valve configured to control fluid communication between the cylinder and an exhaust passage. The air expander is operable in an AEF mode that includes a first stroke in which compressed air stored in the air storage tank and added fuel are supplied to the cylinder and combusted to drive the piston down and rotate the crankshaft. The AEF mode also includes a second stroke in which exhaust products are forced through the open exhaust valve by the piston as it rises in the cylinder.

The present invention further provides devices, systems, and methods as claimed.

### BRIEF DESCRIPTION OF THE DRAWINGS

The invention will be more fully understood from the following detailed description taken in conjunction with the accompanying drawings, in which:

FIG. 1 is a schematic cross-sectional view of a prior art air hybrid split-cycle engine;

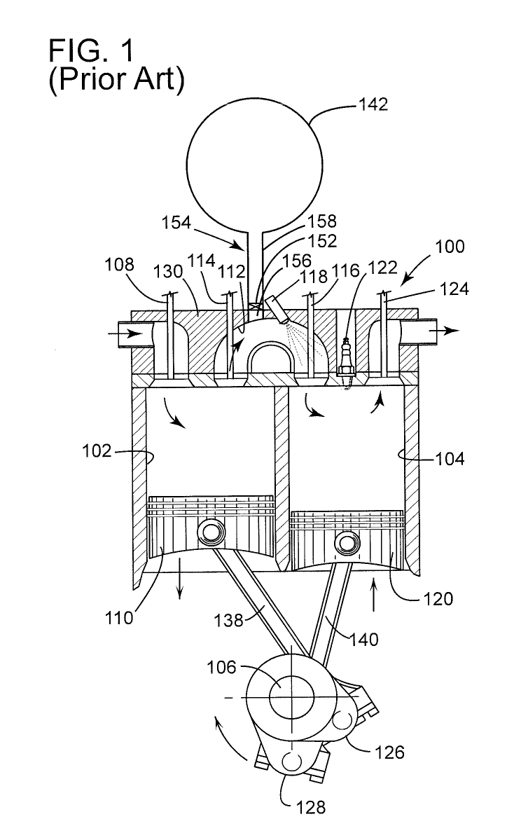

FIG. 2 is a schematic diagram of a CAES system according to at least one embodiment of the present invention;

FIG. 3 is a schematic diagram of the CAES system of FIG. 2 operating in an energy storage mode;

FIG. 4 is a schematic diagram of the CAES system of FIG. 2 operating in an energy conversion mode;

FIG. 5 is a schematic diagram of the CAES system of FIG. 2 operating in a backup energy generation mode;

FIG. 6 is a schematic diagram of the CAES system of FIG. 2 operating in a backup energy generation and recharge mode;

FIG. 7 depicts simulation data for one embodiment of a CAES system in which a split-cycle engine operating in AE mode is used for energy conversion;

FIG. 8 depicts simulation data for the CAES system of FIG. 7 in which a split-cycle engine operating in AC mode is used for energy storage;

FIG. 9 depicts simulation data for one embodiment of a CAES system in which a split-cycle engine operating in AEF mode is used for energy conversion;

FIG. 10 depicts simulation data for the CAES system of FIG. 9 in which a split-cycle engine operating in AC mode is used for energy storage;

FIG. 11 is a schematic diagram of an exemplary cylinder deactivation system for use with a split-cycle engine; and

FIG. 12 is a schematic diagram of an exemplary air expander for use in a CAES system.

### DETAILED DESCRIPTION

Certain exemplary embodiments will now be described to provide an overall understanding of the principles of the structure, function, manufacture, and use of the methods, systems, and devices disclosed herein. One or more examples of these embodiments are illustrated in the accompanying drawings. Those skilled in the art will understand that the methods, systems, and devices specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

Although certain methods and devices are disclosed herein in the context of a split-cycle engine and/or an air hybrid engine, a person having ordinary skill in the art will appreciate that the methods and devices disclosed herein can be used in any of a variety of contexts, including, without limitation, non-hybrid engines, two-stroke and four-stroke engines, conventional engines, natural gas engines, diesel engines, etc.

System

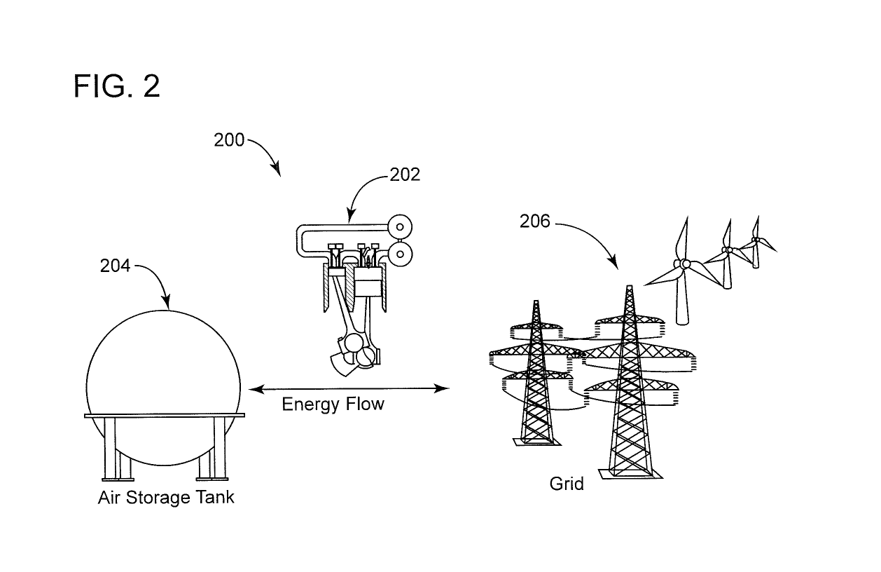

FIGS. 2-6 illustrate one exemplary embodiment of a compressed air energy storage (CAES) system 200. As shown in FIG. 2, the system 200 uses a split-cycle engine 202 to control and facilitate energy flow between an air storage tank 204 and a power grid 206. Together, the split-cycle engine 202 and the air storage tank 204 can be considered an air hybrid split-cycle engine. While one split-cycle engine 202 and one air storage tank 204 are shown, this is merely for the sake of brevity, and it will be appreciated that the system can include any number of split-cycle engines or air storage tanks.

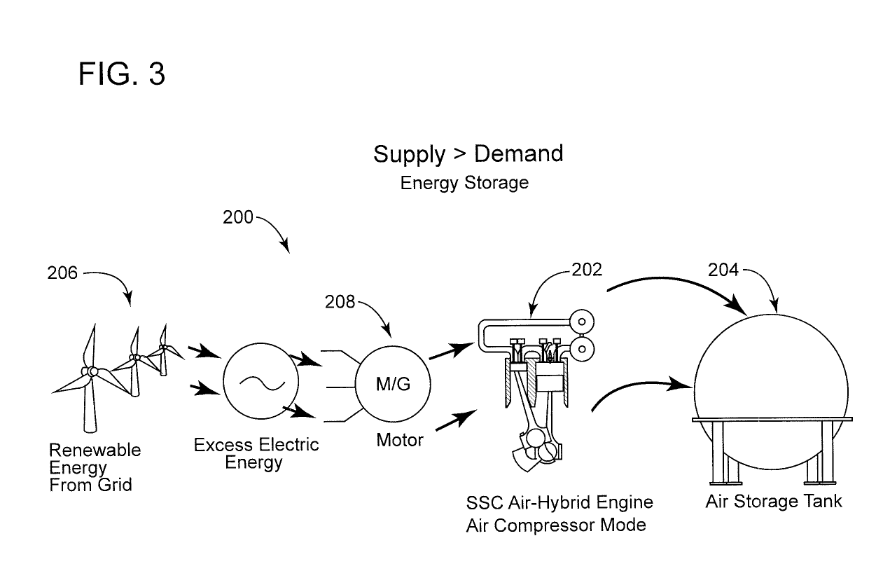

As shown in FIG. 3, the system 200 can operate in an energy storage mode when energy output from a power source 206 (e.g., a renewable energy power system, a solar power system, a wind power system, a geothermal power system, a hydroelectric power system, etc.) exceeds the demand for such energy. In the energy storage mode, excess electric energy generated by the power source 206 drives an electric motor 208 having an output shaft coupled to the crankshaft of the split-cycle engine 202. During this time, the split-cycle engine 202 is controlled to operate in AC mode to compress air into the air storage tank 204. In some embodiments, the split-cycle engine 202 can have a high geometric compression ratio in the compression cylinder (e.g., about 95:1) which can enable very efficient air compression. In an exemplary embodiment, the air storage tank 204 can be filled to a pressure of between about 30 bar and about 50 bar.

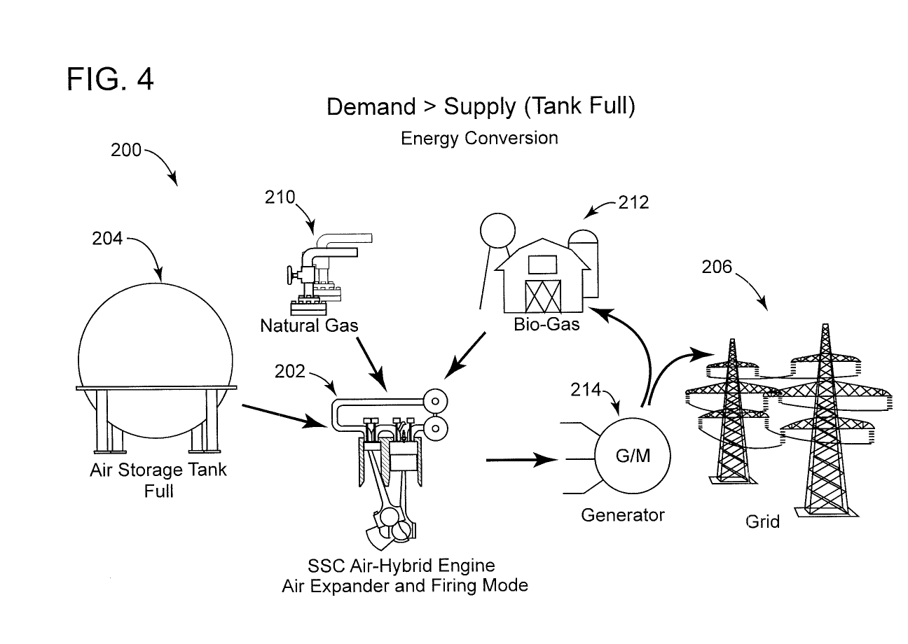

As shown in FIG. 4, the system 200 can operate in an energy conversion mode when energy output from the power source 206 is less than the demand for such energy and the air storage tank 204 is not empty. In the energy conversion mode, compressed air stored in the air storage tank 204 is fed to the split-cycle engine 202 along with a combustible fuel such as natural gas 210 or bio-gas 212. The term bio-gas generally refers to a gas produced by the biological breakdown of organic matter in the absence of oxygen. Organic waste such as dead plant and animal material, animal feces, and kitchen waste can be converted into a gaseous fuel called bio-gas. During this time, the split-cycle engine 202 is controlled to operate in AEF mode. As compressed air supplied from the air storage tank 204 and the combustible fuel are ignited, the split-cycle engine 202 drives a generator 214 having an input shaft coupled to the crankshaft of the split-cycle engine 202. The generator 214 in turn produces electric power that is fed into the power grid 206. As shown, the output electric power can also be used to power a plant for generating or processing bio-gas 212.

In some embodiments, the split-cycle engine 202 can have a high geometric compression ratio in the expansion cylinder (e.g., about 50:1) and can achieve very high efficiencies (e.g., 60% or more). In the split-cycle engine 202, combustion can occur after the expansion piston reaches top dead center, which can advantageously avoid recompression of pressurized air as it enters the expansion cylinder in AEF mode. It is structurally impossible to efficiently obtain this advantage in a conventional engine. Also, combustion of fuel and air in a split-cycle engine operating in AEF mode utilizes approximately 5 times less air than is required in a system which uses only air expansion for conversion to electric power. Therefore, in the system 200, the air storage tank 204 can have a smaller volume and lower maximum pressure per unit of stored energy as compared to a system that relies only on air expansion. Nonetheless, in some embodiments, the split-cycle engine 202 can operate in AE mode instead of AEF mode during the energy generation phase of system operation.

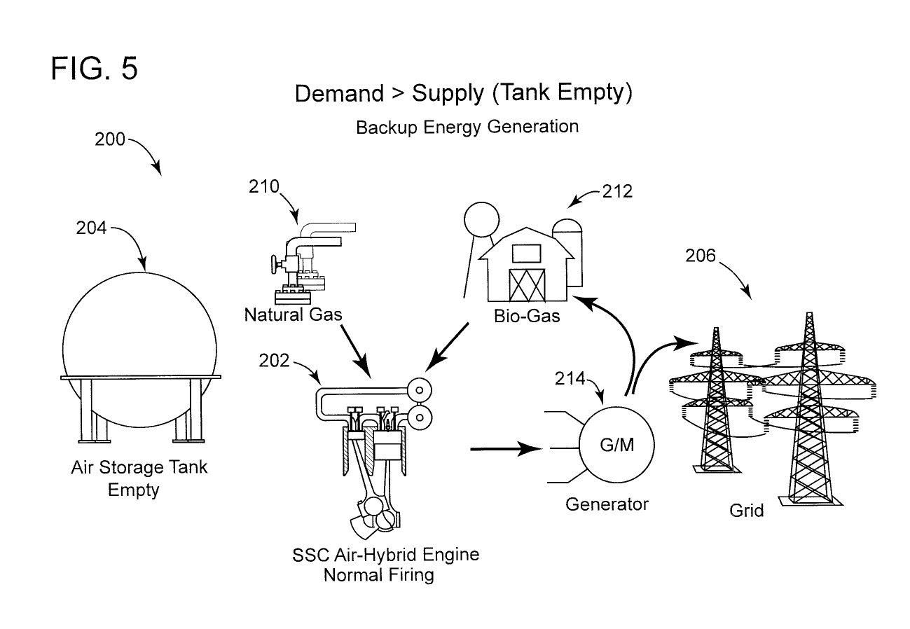

As shown in FIG. 5, the system 200 can operate in a backup energy generation mode when the supply of compressed air in the air storage tank 204 is depleted, such that the system 200 can continue supplying the required electric power output. In the backup energy generation mode, the split-cycle engine 202 is controlled to operate in NF mode, using air supplied from the atmosphere and a combustible fuel (e.g., natural gas 210 or bio-gas 212). As the fuel is ignited, the split-cycle engine 202 drives the generator 214 to provide electric power to the power grid 206. Thus, the system 200 can continue to supply energy to the power grid 206 regardless of whether any compressed air remains in the air storage tank 204. Advantageously, the NF mode of operation of a split-cycle engine provides diesel-like thermal efficiency (e.g., greater than about 44%) and diesel-like specific torque (e.g., greater than about 30 bar) using a cleaner, lower emissions fuel such as natural gas.

In some embodiments, the split-cycle engine 202 produces twice as much output power in NF mode as it does in AEF mode for a given load. Accordingly, when the split-cycle engine 202 is sized to meet a desired output when operating at full load in AEF mode, the same desired output can be met while operating at only about 50% load in NF mode. This can introduce efficiency concerns during backup generation phases of operation, as the engine is generally more efficient when operating at full load than when operating at part load.

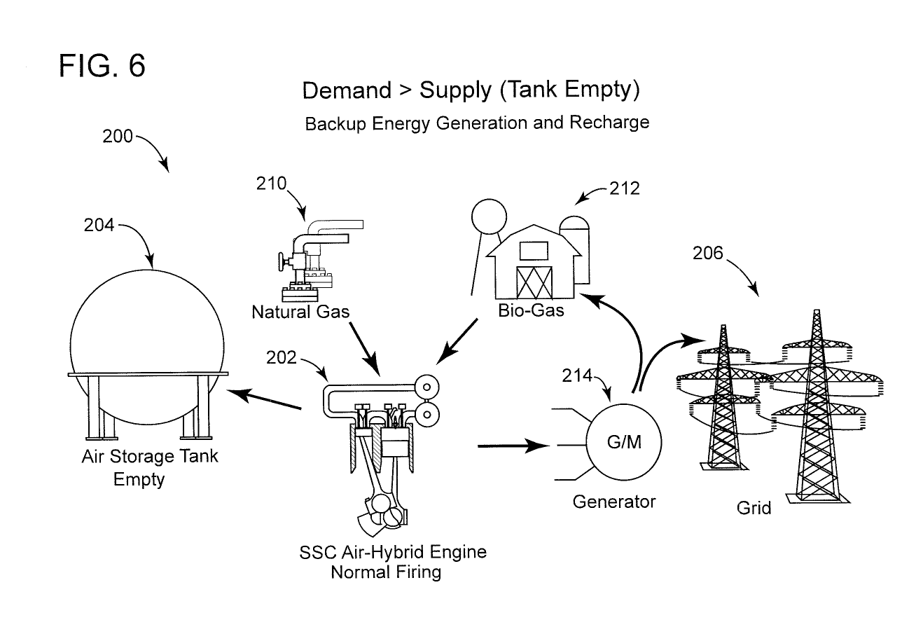

One way to address such concerns is to operate the system 200 in a backup energy generation and recharge mode, as shown in FIG. 6. In the backup energy generation and recharge mode, the split-cycle engine 202 is controlled to operate in FC mode using air supplied from the atmosphere and a combustible fuel such as natural gas or bio-gas. This is in contrast to the NF mode used in the backup energy generation mode of FIG. 5. In the FC mode, air that is compressed by the compression side of the engine 202 is stored in the air storage tank 204, thereby recharging the supply of compressed air. At the same time, the output of the engine 202 drives the generator 214 to supply electric power to the power grid 206. Using the operating mode of FIG. 6, the split-cycle engine 202 can be operated at full load during the backup energy generation phase of operation, with any energy exceeding the demand load being used instead to compress air into the air storage tank 204 for subsequent use. In other words, when the split-cycle engine 202 is operating as a backup generator, it can still run at full load, using a portion of the output energy to satisfy the power demand of the attached load and using the remaining portion of the output energy to recharge the air storage tank 204. The engine 202 can thus run at full load and high efficiency, even when the power demand of the attached load is less than the maximum output of the engine 202. In some embodiments, the system 200 can continuously alternate between the energy conversion mode of FIG. 4 and the backup energy generation and recharge mode of FIG. 6 to repeatedly drain and fill the air storage tank 204.

In some embodiments, the electric motor 208 used in the energy storage mode and the generator 214 used in the energy conversion, backup energy generation, and backup energy generation and recharge modes are the same physical component. In other embodiments, the motor 208 and generator 214 are separate physical components of the system 200.

In some embodiments, a plurality of split-cycle engines 202 can be provided, each performing a particular function within the system. In other embodiments, a single split-cycle engine 202 can be provided that performs all of the operating modes of the system 200. This can advantageously permit three functions to be consolidated into a single machine (the split-cycle engine 202). In particular, the compressor function required in the energy storage mode, the expander function required in the energy conversion mode, and the generation function required in the backup energy generation modes can all be performed by the same split-cycle engine 202. In contrast to traditional CAES systems which require separate sets of turbines for the storage and conversion functions, as well as separate generators for the backup function, the system 200 of FIGS. 2-6 can permit each of these functions to be implemented in a single, small, and inexpensive package. In an exemplary embodiment, a system capable of producing one megawatt of electric power per hour can be packaged in a footprint that is less than about 10 meters by 5 meters by 5 meters. A traditional CAES system with the same output capacity can require a much larger footprint.

Simulation

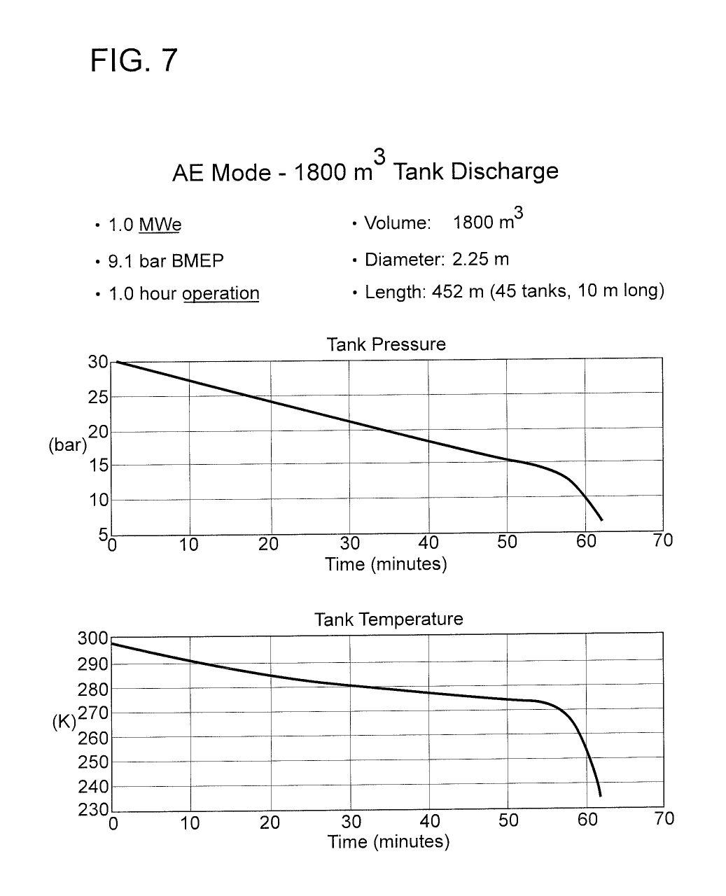

FIGS. 7-10 illustrate simulation data from a rough order of magnitude estimation of the various design parameters for a split-cycle-engine-based CAES system. Using engine maps for a gasoline SCUDERI AIR HYBRID SPLIT-CYCLE ENGINE, engine displacement was scaled to achieve a 1 megawatt per hour installed power when operating at full load in AEF mode. The resulting displacement of 70 liters for a two-cylinder engine is a conservative estimate, as it assumes a brake mean effective pressure (BMEP) of only about 22 bar (a similar natural gas engine can achieve a BMEP of about 32 bar) and does not take into account efficiency gains that result from a larger cylinder bore. Accordingly, using a natural gas engine, the displacement can be smaller, e.g., about 50 liters. In the simulation, it was assumed that the electric motor/generator has a 94% efficiency and that the engine speed is 2000 rpm. In some embodiments, the engine speed can be higher or lower, e.g., about 1000 rpm. It was also assumed that the full load BMEPs for the split-cycle engine are 22.2 bar (for NF mode), 9.1 bar (for AE mode), 12.2 bar (for AEF mode), and −5.3 bar (for AC mode).

The air storage tank size required to produce 1 megawatt per hour installed power was then determined for a scenario in which the split-cycle engine operates in AE mode during the energy conversion phase and a scenario in which the split-cycle engine operates in AEF mode during the energy conversion phase.

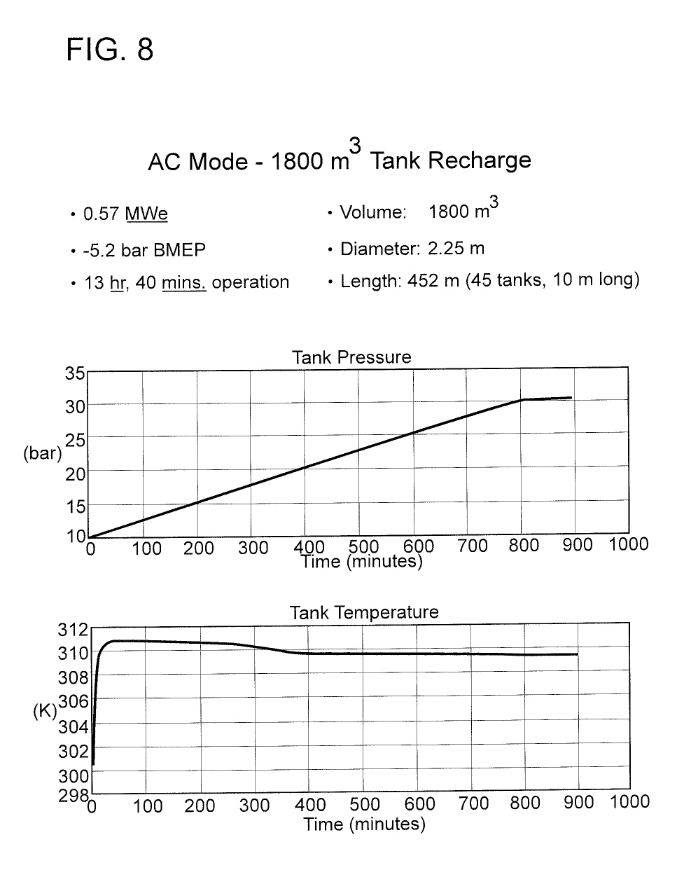

As shown in FIG. 7, a system in which AE mode only is used for energy conversion requires an air storage tank having a volume of about 1800 cubic meters. Assuming a tank diameter of 2.25 meters, this would require forty-five tanks, each 10 meters long. As shown in FIG. 8, this same system would require 13 hours and 40 minutes to recharge the air supply tank using AC mode.

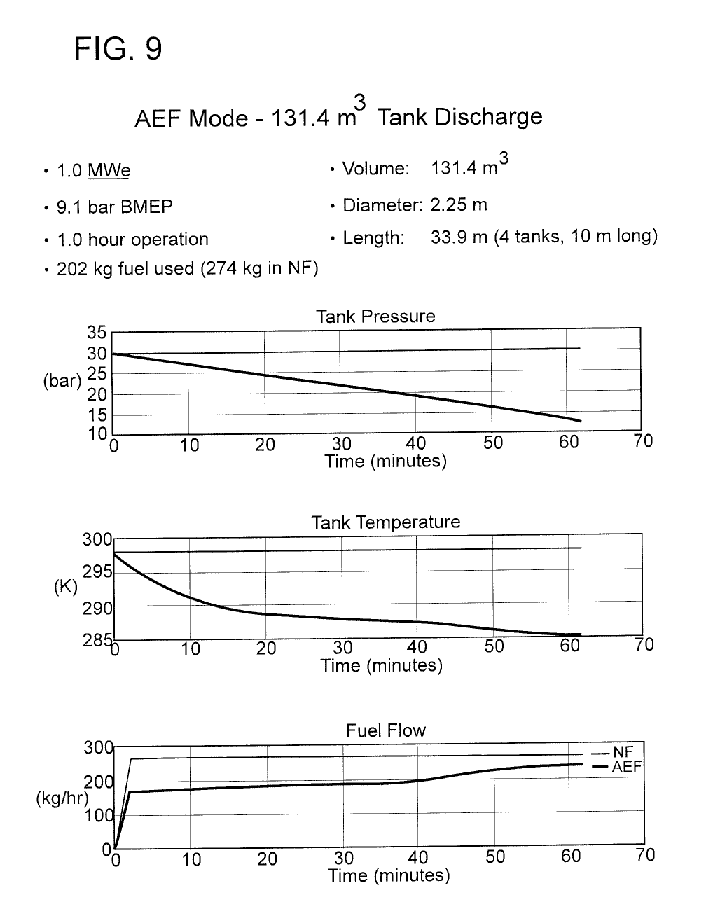

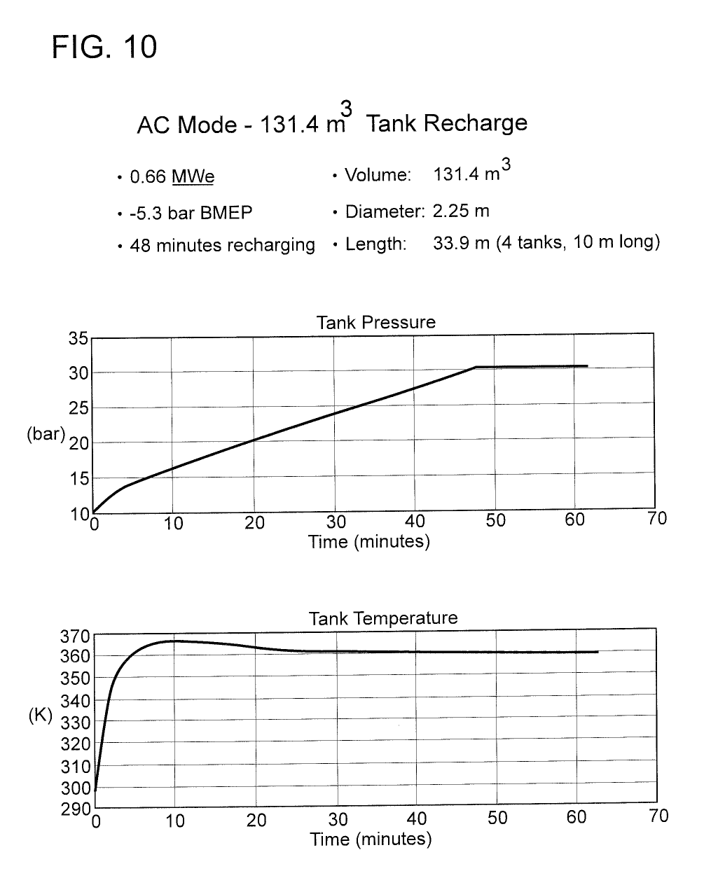

As shown in FIG. 9, a system in which AEF mode is used for energy conversion is more practical, requiring an air storage tank having a volume of only about 131.4 cubic meters. Assuming a tank diameter of 2.25 meters, this would require only four tanks, each 10 meters long. As shown in FIG. 10, this same system would require only 48 minutes to recharge the air supply tank using AC mode.

The simulation results demonstrate that a 1 megawatt-hour CAES system according to one embodiment of the present invention can be constructed with a footprint that is small compared to that required for traditional CAES systems.

Cylinder Deactivation

The split-cycle engines used in the CAES systems described above can operate in several air hybrid modes in which one or more cylinders are deactivated or offloaded. For example, the expansion cylinder is typically offloaded while operating in AC mode, and the compression cylinder is typically offloaded while operating in AE and AEF modes. In some embodiments, the compression cylinder can be offloaded by holding the intake valve open or closed throughout the engine cycle. Likewise, the expansion cylinder can be offloaded by holding the exhaust valve open or closed throughout the engine cycle. While these techniques can be effective in offloading the cylinder, some efficiency is still lost in the offloaded cylinder due to the frictional forces acting between the piston and the surrounding cylinder wall.

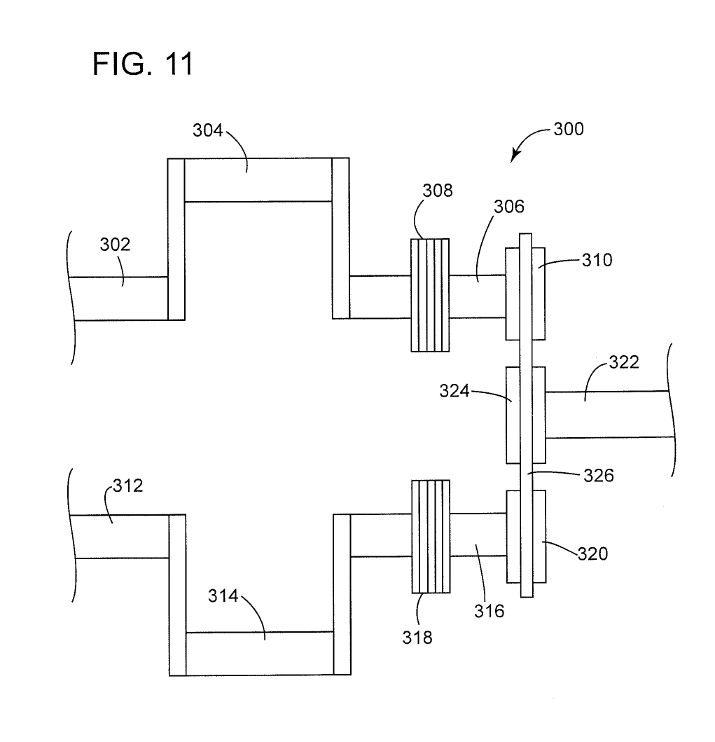

FIG. 11 illustrates one exemplary embodiment of a cylinder deactivation system 300 for use with a split-cycle engine which allows one or more pistons to be selectively decoupled from the rotating assembly of the engine, thereby offloading the cylinder while at the same time eliminating the frictional drag and efficiency losses that would otherwise result. In some embodiments, split-cycle engines used in a CAES system are stationary and not subject to the same usability considerations as, for example, an automotive split-cycle engine. Accordingly, it can be acceptable to bring the engine to a complete stop for decoupling one or more pistons. It will also be appreciated though that the pistons can be decoupled while the engine continues to rotate (i.e., without stopping the engine).

As shown in FIG. 11, the cylinder deactivation system 300 includes a first crankshaft 302 having a crank throw 304 to which a compression piston (not shown) is coupled. The first crankshaft 302 is selectively coupled to a first pulley shaft 306 via a clutch 308. The first pulley shaft 306 includes a first pulley 310.

The system 300 also includes a second crankshaft 312 having a crank throw 314 to which an expansion piston (not shown) is coupled. The second crankshaft 312 is selectively coupled to a second pulley shaft 316 via a clutch 318. The second pulley shaft 316 includes a second pulley 320.

The system 300 also includes an output shaft 322 having an output shaft pulley 324 attached at one end. The other end of the output shaft 322 can be coupled to other components in a CAES system, such as the output shaft of an electric motor 208 or the input shaft of a generator 214. The first pulley 310, second pulley 320, and output shaft pulley 324 are linked by a linkage 326 (e.g., a belt or a chain) such that rotation of any one of said pulleys causes rotation of the other pulleys. Each of the pulleys 310, 320, 324 can have the same diameter, or they can have varying diameters to scale the degree to which rotation of one pulley is translated to the others.

During AE or AEF modes of operation, for example, the clutch 308 can be actuated to decouple the first crankshaft 302 and the compression piston from the rest of the engine's rotating assembly. This allows the compression piston and first crankshaft 302 to remain stationary, avoiding efficiency losses introduced by friction between the compression piston and the compression cylinder. Meanwhile, the second crankshaft 312 and the expansion piston remain coupled to the output shaft 322 of the engine.

During AC modes of operation, for example, the clutch 318 can be actuated to decouple the second crankshaft 312 and the expansion piston from the rest of the engine's rotating assembly. This allows the expansion piston and second crankshaft 312 to remain stationary, avoiding efficiency losses introduced by friction between the expansion piston and the expansion cylinder. Meanwhile, the first crankshaft 302 and the compression piston remain coupled to the output shaft 322 of the engine.

It will thus be appreciated that the cylinder deactivation system 300 of FIG. 11 allows for more efficient cylinder offloading in split-cycle engines used with CAES systems.

Air Expander

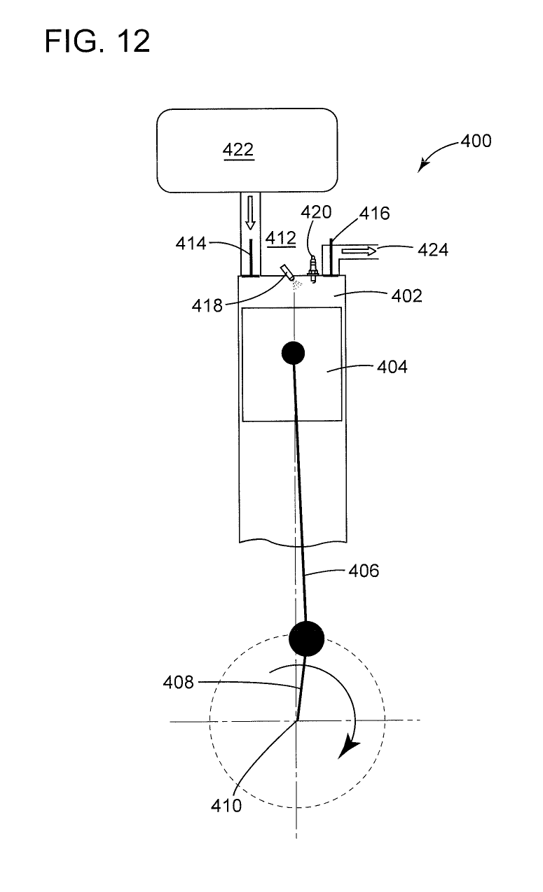

FIG. 12 illustrates an exemplary embodiment of a dedicated air expander 400 that can be used in the energy conversion mode described above with respect to FIG. 4. One of the primary efficiency gains provided by the systems described above is the ability to convert energy stored as compressed air into electricity using an AEF mode of operation. The expander 400 of FIG. 12 allows for this AEF mode of operation without the efficiency drain posed by an offloaded compression cylinder or the additional complexity posed by a cylinder deactivation system.

As shown, the expander 400 includes an expansion cylinder 402 having an expansion piston 404 reciprocally disposed therein. A connecting rod 406 couples the expansion piston 404 to a crankshaft 408 that rotates about a crankshaft axis 410. The top of the expansion cylinder 402 is closed by a cylinder head 412 having an intake valve 414 and an exhaust valve 416 disposed therein, along with a fuel injector 418 and a spark plug 420. The intake valve 414 controls fluid communication between an air storage tank 422 and the expansion cylinder 402, and the exhaust valve 416 controls fluid communication between the expansion cylinder 402 and an exhaust passage 424.

In operation, compressed air stored in the air storage tank 422 is supplied to the expansion cylinder 402 through the intake valve 414 as the expansion piston reaches top dead center. The fuel injector 418 is then actuated to add fuel to the compressed air charge in the expansion cylinder 402, and the spark plug 420 is fired just after the expansion piston 404 reaches top dead center to ignite the air-fuel mixture. The resulting combustion drives the expansion piston 404 down in a power stroke, rotating the crankshaft 408 about the crankshaft axis 410. After the expansion piston 404 reaches bottom dead center and begins ascending within the cylinder 402, the exhaust valve 416 is opened to allow combustion products to be evacuated from the cylinder 402 by the rising expansion piston 404 in an exhaust stroke. The exhaust valve 416 is closed shortly before the piston 404 reaches top dead center, and before the intake valve 404 is opened in the next cycle. This cycle of a power (or “expansion”) stroke and an exhaust stroke then repeats.

The air expander 400 of FIG. 12 thus provides a system capable of AEF mode operation and having minimal complexity and efficiency losses. It will be appreciated that the structure and function of the air expander described above is merely exemplary and that a number of variations are possible and within the scope of the present invention. For example, any of the variations described with respect to split-cycle engines in the background section of this application and in the disclosures incorporated by reference herein can be applied to the air expander 400.

While the illustrated air expander 400 has application in CAES systems such as those disclosed above, it can also be used in any of a variety of other contexts. For example, the air expander 400 can be used with a tank of compressed air to power lawn mowers, golf carts, landscaping trimmers, snow throwers, or any of a variety of other machines that can be powered by an internal combustion engine. In such applications, the tank of compressed air can be recharged between uses of the machine, for example via a standalone air compressor.

Although the invention has been described by reference to specific embodiments, it should be understood that numerous changes may be made within the spirit and scope of the inventive concepts described. Accordingly, it is intended that the invention not be limited to the described embodiments, but that it have the full scope defined by the language of the following claims.

What is claimed is:

1. A compressed air energy storage system, comprising:
a split-cycle engine;
an electric motor/generator operatively coupled to a crankshaft of the split-cycle engine; and
an air storage tank in fluid communication with a crossover passage of the split-cycle engine;
wherein the system is operable in at least:
an energy storage mode in which energy supplied from a power grid drives the electric motor/generator to turn the split-cycle engine to store compressed air in the air storage tank; and
an energy conversion mode in which compressed air stored in the air storage tank is supplied with fuel to the split-cycle engine and combusted to drive the electric motor/generator and supply electric power to the power grid.

2. The system of claim 1, wherein the split-cycle engine operates in AC mode during the energy storage mode of system operation.

3. The system of claim 1, wherein the split-cycle engine operates in AEF mode during the energy conversion mode of system operation.

4. The system of claim 1, wherein the fuel comprises at least one of natural gas and bio-gas.

5. The system of claim 1, wherein the system is also operable in a backup energy generation mode in which the split-cycle engine operates in an NF mode to drive the electric motor/generator to supply electric power to the power grid.

6. The system of claim 1, wherein the system is also operable in a backup energy generation and recharge mode in which the split-cycle engine operates in an FC mode to drive the electric motor/generator to supply electric power to the power grid and to simultaneously store compressed air in the air storage tank.

7. The system of claim 1, wherein the system operates in the energy storage mode when energy supplied from the power grid exceeds energy demand.

8. The system of claim 1, wherein the system operates in the energy conversion mode when energy supplied from the power grid does not exceed energy demand and there is compressed air stored in the air storage tank.

9. The system of claim 5, wherein the system operates in the backup energy generation mode when energy supplied from the power grid does not exceed energy demand and there is no compressed air stored in the air storage tank.

10. The system of claim 1, wherein the power grid includes a renewable energy source.

11. The system of claim 10, wherein the renewable energy source comprises at least one of a wind power system, a solar power system, a hydroelectric power system, and a geothermal power system.

12. A method of operating a compressed air energy storage system, comprising:
in an energy storage mode, driving an electric motor/generator with energy from a power grid to turn a split-cycle engine to store compressed air in an air storage tank; and
in an energy conversion mode, combusting a mixture of fuel and compressed air supplied from the air storage tank in the split-cycle engine to drive the electric motor/generator and supply electric power to the power grid.

13. The method of claim 12, further comprising operating the split-cycle engine in AC mode during the energy storage mode of system operation.

14. The method of claim 12, further comprising operating the split-cycle engine in AEF mode during the energy conversion mode of system operation.

15. The method of claim 12, wherein the fuel comprises at least one of natural gas and bio-gas.

16. The method of claim 12, further comprising, in a backup energy generation mode, operating the split-cycle engine in an NF mode to drive the electric motor/generator to supply electric power to the power grid.

17. The method of claim 12, further comprising, in a backup energy generation and recharge mode, operating the split-cycle engine in an FC mode to drive the electric motor/generator to supply electric power to the power grid and to simultaneously store compressed air in the air storage tank.

18. The method of claim 12, wherein the energy storage mode is used when energy supplied from the power grid exceeds energy demand.

19. The method of claim 12, wherein the energy conversion mode is used when energy supplied from the power grid does not exceed energy demand and there is compressed air stored in the air storage tank.

20. The system of claim 16, wherein the backup energy generation mode is used when energy supplied from the power grid does not exceed energy demand and there is no compressed air stored in the air storage tank.

21. The method of claim 12, wherein the power grid includes a renewable energy source.

22. The method of claim 21, wherein the renewable energy source comprises at least one of a wind power system, a solar power system, a hydroelectric power system, and a geothermal power system.

23. A cylinder deactivation system, comprising:
a first crankshaft having a first crank throw coupled to a compression piston of a split-cycle engine;
a second crankshaft having a second crank throw coupled to an expansion piston of the split-cycle engine;
a first clutch configured to selectively couple the first crankshaft to a first pulley shaft having a first pulley mounted thereon;
a second clutch configured to selectively couple the second crankshaft to a second pulley shaft having a second pulley mounted thereon;
an output shaft having an output pulley mounted thereon; and
a linkage configured to transmit rotation between each of the first pulley, the second pulley, and the output pulley.

24. The system of claim 23, wherein actuating the first clutch decouples the first crankshaft from the first pulley shaft such that the compression piston remains stationary while the expansion piston reciprocates to drive the output shaft.

25. The system of claim 23, wherein actuating the second clutch decouples the second crankshaft from the second pulley shaft such that the expansion piston remains stationary while the compression piston reciprocates as the output shaft is externally driven.

26. The system of claim 23, wherein the linkage comprises at least one of a belt and a chain.

27. An air expander, comprising:
a cylinder;
a piston reciprocally disposed in the cylinder and coupled to a crankshaft;
an intake valve configured to control fluid communication between the cylinder and an air storage tank;
an exhaust valve configured to control fluid communication between the cylinder and an exhaust passage;
wherein the air expander is operable in an AEF mode comprising:
a first stroke in which compressed air stored in the air storage tank and added fuel are supplied to the cylinder and combusted to drive the piston down and rotate the crankshaft; and
a second stroke in which exhaust products are forced through the open exhaust valve by the piston as it rises in the cylinder.
